(19) United States
(12) Patent Application Publication
(10) Pub. No.: US 2022/0322104 A1
(43) Pub. Date: Oct. 6, 2022

(54) MOBILE WIRELESS BASE STATIONS, NETWORK USAGE MONITORING, AND DEPLOYMENT

(71) Applicant: Charter Communications Operating, LLC, St. Louis, MO (US)

(72) Inventor: Michael Bender, Rye Brook, NY (US)

(21) Appl. No.: 17/217,089

(22) Filed: Mar. 30, 2021

(51) Int. Cl. H04W 16/20; H04W 4/021; H04W 72/08

(52) U.S. Cl. CPC H04W 16/20; H04W 4/021; H04W 72/087

(57) ABSTRACT

A communication management resource monitors delivery of content over a wireless network. In response to detecting a condition indicating a temporary or long term need for (additional or initial) wireless services in a first geographical region, the communication management resource deploys a mobile wireless base station in the first geographical region to support the need for wireless services.

### BACKGROUND

According to conventional techniques, a wireless base station is a radio receiver/transmitter that serves as a hub to local wireless communication devices. In general, the wireless base station is a gateway between a wireless network and a wired network.

Wireless base stations are typically deployed in geographical regions where many people frequent. For example, the greater the number of users in a geographical region, a greater density of wireless base stations is typically deployed in that geographical region.

Conventional wireless base stations are implemented as fixed communication devices. The wireless network typically supports mobility from one geographical region to the next via so-called wireless handoffs. As its name suggests, a wireless handoff is an event in which a first wireless base station serving a first geographical region hands off wireless connectivity of a respective mobile communication device to a second wireless base station in a second geographical region. The handoff ensures that the mobile communication device is provided continuous wireless connectivity to a remote network such as the Internet.

It is further noted that conventional edge computing is a decentralized architecture that supports mobile computing and moves computer processors from central computer systems closer to the consumers. The introduction of 5G cellular wireless and edge computing allows for optimization of storing shared files at locations closest to the consumers—at the periphery of the network.

### BRIEF DESCRIPTION OF EMBODIMENTS

This disclosure includes the observation that conventional wireless base stations suffer from deficiencies. For example, conventional wireless base stations are fixed at a particular location and do not accommodate changing wireless network conditions. In certain instances, only temporarily wireless services are required in a geographical region such as during an event in which many users congregate for a brief period of time. Deployment of fixed wireless base stations at such locations is expensive and does not result in sufficient return to warrant fixed installation at those locations.

Embodiments herein provide novel ways of providing improved wireless communications to one or more communication devices in a network environment. For example, embodiments herein include a computer enabled methodology to dynamically locate mobile networking resources and/or storage capacity to locations with increased demand based on predicting future demand from historical analysis and current information feeds.

More specifically, in one embodiment, a communication management resource (such as communication management hardware, communication management software, or a combination of communication management hardware and communication management software) monitors delivery of content (digital data) over a wireless network. In response to detecting a condition indicating a temporary (or long term) need for (such as additional or primary) wireless services in a first geographical region, the communication management resource as discussed herein deploys a mobile wireless base station in the first geographical region to support the need for wireless services.

Further embodiments herein include any of the one or more operations as discussed herein.

In further example embodiments, the detected condition is a scheduled gathering of people in the first geographical region (such as a first location, first locations, etc.). In a specific implementation, the communication management resource deploys one or more mobile wireless base stations in a vicinity of the first geographical region at a time of the scheduled gathering to support the temporary need for additional wireless services.

In accordance with further example embodiments, the condition (such as need for wireless services) indicates an inability of fixed wireless base station resources in the first geographical region to provide sufficient network access to mobile communication devices in the first geographical region.

In still further example embodiments, monitoring the delivery of content includes storing a history of wireless network access by users in the first geographical region over time. Detecting the condition includes anticipating occurrence of the condition in the first geographical region based on the stored history of wireless access.

Further embodiments herein include, via the communication management resource, based on attributes of the detected condition, identifying a first type of data expected to be retrieved by communication devices in the first geographical region; storing the first type of data expected to be retrieved by the communication devices from the wireless mobile base station; and distributing the first type of data from the mobile wireless base station (such as a network edge device or gateway) to the communication devices.

Note further that the one or more mobile wireless base stations as discussed herein can be deployed in any suitable manner. For example, in one embodiment, the communication management resource deploys the mobile wireless base station on a ground-based vehicle (such as a truck, automobile, etc.) steered to the desired location where wireless services are needed. In accordance with another example embodiment, the communication management resource deploys the mobile wireless base station in an air-based vehicle (such as a drone, balloon, etc.) steered to the desired location where wireless services are needed.

In accordance with further example embodiments, the communication management resource receives feedback (such as from a mobile wireless base station or other suitable entity) indicating a degree of success associated with deployment of the mobile wireless base station to temporarily provide the wireless services in the first geographical region.

Still further example embodiments herein include, prior to the deployment of the mobile wireless base station, via the communication management resource, monitoring delivery of content in the first geographical region in which the wireless network resides; and monitoring delivery of content in a second geographical region (such as a second location or second locations) in which the wireless network resides.

In one embodiment, in addition to detecting a first condition indicating the temporary need for additional wireless services in a first geographical region, the communication management resource detects a second condition indicating a temporary need for additional wireless services in a second geographical region. In one embodiment, wireless resources such as multiple mobile wireless base station are limited. In such an instance, the communication management resource may not be able to deploy a respective mobile wireless base station to each geographical region (such as zone) requiring or requesting wireless services. In one embodiment, the communication management resource produces ranking information ranking the temporary need to provide additional wireless services in the first geographical region versus the temporary need to provide additional wireless services in the second geographical region. If only one mobile wireless base station is available for deployment, then the communication management resource deploys the available mobile wireless base station to the geographical region ranked highest in the ranking information (indicating the geographical region most in need.

In still further example embodiments, the communication management resource controls the mobile wireless base station to transmit a wireless signal in the first geographical region; the wireless signal indicates availability of the additional wireless services.

Still further example embodiments herein include, via the communication management resource or other suitable entity, controlling the mobile wireless base station to transmit a wireless signal in the first geographical region where it is deployed. In one embodiment, the wireless signal indicates an identity of a wireless network service provider providing the additional wireless services from the mobile wireless base station.

Embodiments herein are useful over conventional techniques. For example, as previously discussed, wireless services may not be required at a given geographical location except on a temporary basis. Deployment of mobile wireless base stations as discussed herein provides an economical way to increase wireless service capacity to different regions on an as-needed basis via shared use of mobile wireless base stations.

Note that any of the resources as discussed herein can include one or more computerized devices, communication management resources, mobile communication devices, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium (such as any computer readable hardware storage medium, computer readable storage hardware, etc.) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage hardware medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed on a computerized device to cause the computerized device to perform the techniques explained herein.

Accordingly, embodiments herein are directed to a method, system, computer program product, etc., that supports operations as discussed herein.

One embodiment includes a computer readable storage medium and/or system having instructions stored thereon to provide efficient use of wireless resources in a network environment. The instructions, when executed by computer processor hardware, cause the computer processor hardware (such as one or more co-located or disparately processor devices or hardware) to: monitor delivery of content over a wireless network; detect a condition indicating a temporary need for additional wireless services in a first geographical region; and in response to detecting the condition, deploy a mobile wireless base station in the first geographical region to support the temporary need for additional wireless services.

Note that the ordering of the steps above has been added for clarity sake. Further note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing communication services. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example diagram illustrating a wireless network environment and deployment of one or more mobile wireless base stations to provide wireless services according to embodiments herein.

FIG. 2 is an example diagram illustrating monitoring of a wireless network environment and deployment of one or more mobile wireless base stations according to embodiments herein.

FIG. 3 is an example diagram illustrating implementation of a mobile wireless base station in response to detected congestion in a particular geographical region in a wireless network environment according to embodiments herein.

FIG. 4 is an example diagram illustrating implementation of a mobile wireless base station at an event such as a private or public gathering of people (users) according to embodiments herein.

FIG. 5 is an example diagram illustrating implementation of one or more docking stations in a wireless network environment to accommodate mobile wireless base stations according to embodiments herein.

FIG. 6 is an example diagram illustrating of a mobile wireless base station from one docking station to another to provide users in different geographical regions wireless network access according to embodiments herein.

FIG. 7 is an example diagram illustrating an outage of a wireless base station according to embodiments herein.

FIG. 8 is an example diagram illustrating implementation of a mobile wireless base station on a service truck to provide wireless network access services during a wireless base station outage according to embodiments herein.

FIG. 9 is an example diagram illustrating an example computer architecture operable to execute one or more operations according to embodiments herein.

FIG. 10 is an example diagram illustrating a method according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

A communication management resource monitors delivery of content over a wireless network. In response to detecting a condition indicating a temporary or long term need for wireless services in a first geographical region, the communication management resource deploys a mobile wireless base station in the first geographical region to support the need for wireless services.

In a more specific example, embodiments herein include a system and method for dynamically moving additional wireless network services and storage to/from locations in a network environment depending on usage patterns. For example, in one embodiment, a wireless base station vehicle such as a 5G node (e.g., a mobile wireless base station) is deployed in an appropriate geographical region such as near highways during rush hour traffic to provide corresponding users wireless access. The same mobile wireless base station is subsequently deployed near an apartment building during the day where many students are watching the same video transmission from their teacher. This allows the mobile wireless base station (node on the drone) to provide traffic information to drivers on the highway and high volume storage and wireless connectivity to students during the day (such as non-rush hour traffic conditions).

In other use cases, the additional capacity provided by a mobile wireless base station can be used for supporting gatherings such as fairs, sporting events, concerts, conferences or other venues where wireless services must be provided to many persons for only short duration of time.

As further discussed herein, such embodiments provide an improvement over conventional techniques since the extra wireless service-storage capacity provided by a respective mobile wireless base station does not need to be permanently deployed and allows for the use of such resources for a limited amount of time.

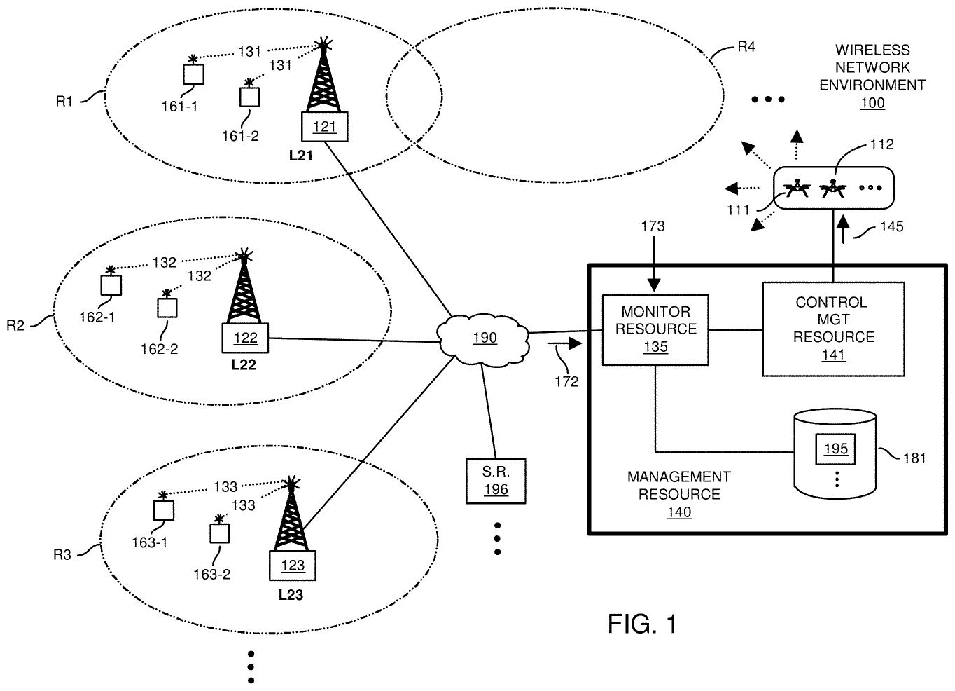

Now, more specifically, with reference to the drawings, FIG. 1 is an example diagram illustrating a wireless network environment and deployment of one or more mobile wireless base stations to provide wireless services in different geographical regions according to embodiments herein.

As shown, wireless network environment 100 includes (communication) management resource 140, network 190, and multiple wireless base stations 121, 122, 123, etc. Management resource 140 includes monitor resource 135, control management resource 141, and repository 181.

As further discussed herein, via generation of transmission line information 145, management resource 140 controls deployment of one or more mobile wireless base stations 111, 112, etc.

Note that the wireless base stations 121, 122, 123, etc., as well as mobile wireless base station 111, 112, etc., support any wireless communication protocol such as LTE (Long Term Evolution), 5G, 4G, Wi-Fi™, etc., over any suitable one or more wireless frequencies.

Note that any of the resources as discussed herein can be configured as hardware, executed software, or a combination of hardware and executed software. For example, management resource 140 can be configured as management hardware, management software, or a combination of management hardware and management software; monitor resource 135 can be configured as monitor hardware, monitor software, or a combination of monitor hardware and monitor software; control management resource 141 (such as a controller) can be configured as control management hardware, control management software, or a combination of control management hardware and control management software; and so on.

Further in this example embodiment, the wireless base station 121 installed at fixed location L21 provides wireless services (i.e., wireless connectivity) to the respective communication devices 161-1, 161-2, etc., present in the respective geographical region R1 (such as a region of wireless coverage). For example, via respective wireless connectivity 131, the wireless base station 121 provides the communication devices 161 (communication device 161-1, 161-2, etc.) access to the remote network 190. Communication devices 161 are mobile or non-mobile communication devices or a combination of both.

The wireless base station 122 installed at fixed location L22 provides wireless services (i.e., connectivity) to the respective communication devices 162-1, 162-2, etc., present in the respective geographical region R2 (such as a region of wireless coverage) For example, via wireless connectivity 132, the wireless base station 122 provides the communication devices 162 (communication device 162-1, 162-2, etc.) access to the remote network 190. Communication devices 162 are mobile or non-mobile communication devices or a combination of both.

The wireless base station 123 installed at fixed location L23 provides wireless services (i.e., connectivity) to the respective communication devices 163-1, 163-2, etc., present in the respective geographical region R3 (such as a region of wireless coverage). For example, via wireless connectivity 133, the wireless base station 123 provides the communication devices 163 (communication device 163-1, 163-2, etc.) access to the remote network 190. Communication devices 163 are mobile communication devices or non-mobile communication devices or a combination of both.

Certain regions in the wireless network environment 100 may not normally be occupied by people (communication device users). In such an instance, there may be no deployment or minimal deployment of wireless base stations in the respective geographical region. In this example embodiment, assume that the geographical region R4 is a rural geographical region in which communication device users rarely frequent except on special events such as rodeos, sporting events, etc.

As previously discussed, management resource 140 (and, more specifically, communication management resource 141) controls operation such as deployment of multiple mobile wireless base stations 111, 112, etc., in the wireless network environment 100 on an as-needed basis.

In one embodiment, as its name suggests, the monitor resource 135 associated with the control management resource 140 monitors the wireless network environment 100 for congestion or other general conditions such as scheduled events. For example, in one embodiment, via feedback 172 from one or more entities such as end user communication devices 161, 162, 163, wireless base stations 121, 122, 123, etc., the management resource 135 receives information such as performance metrics indicating an amount of congestion associated with each wireless base station in the wireless network environment 100 and whether the respective wireless base station can support wireless bandwidth to respective communication devices above a threshold value.

The performance metrics received from one or more entities in the wireless network environment 100 indicate any suitable information such as a wireless bandwidth provided to each of the multiple communication devices. Additionally, or alternatively, the feedback 172 indicates whether additional wireless services are needed in a respective geographical region.

In further example embodiments, the management resource 135 receives input 173 from one or more scheduling entities indicating events scheduled to occur at different locations in the wireless network environment 100. The input 173 such as notification of scheduling potentially includes information regarding the number of people expected at the scheduled event, day and time of the event, information about data (content) to be distributed at the event, etc.

In one embodiment, the input 173 (such as control information) further optionally indicates how many mobile wireless base stations need to be deployed at the time of the event to provide respective communication device users wireless services such as wireless access to the remote network 190 such as the Internet.

More specifically, in one embodiment, the communication management resource 140 monitors delivery of content in the wireless network environment 100. In response to detecting a condition indicating a temporary (or even a long term) need for (such as additional or primary) wireless services in a respective geographical region, the communication management resource 140 deploys a mobile wireless base station in the respective geographical region to support the need for wireless services.

As previously discussed, embodiments herein are useful over conventional techniques. For example, as previously discussed, wireless access services may not be required at a given geographical location except on a temporary as-needed basis. Deployment of mobile wireless base stations as discussed herein provides an economical way to increase wireless service capacity to different regions in a wireless network environment 100 via shared use of mobile wireless base stations.

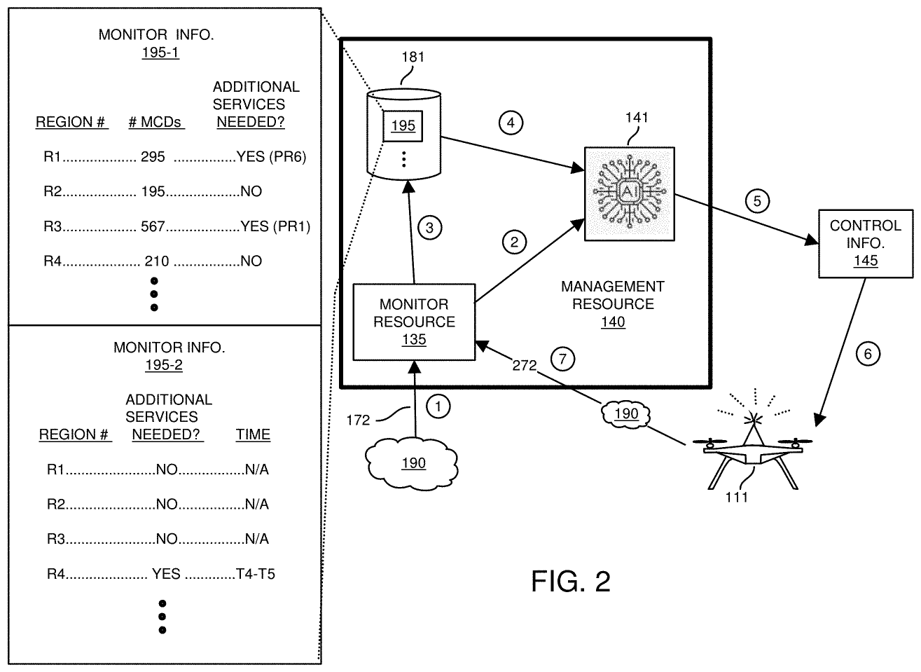

FIG. 2 is an example diagram illustrating monitoring of a wireless network environment and deployment of one or more mobile wireless base stations according to embodiments herein.

In this non-limiting example embodiment, in operation #1, the monitor resource 135 of the management resource 140 receives feedback 172 (i.e., input) indicating current or scheduled operating conditions associated with providing wireless network services to communication devices at different geographical regions of the wireless network environment 100.

In operation #2, the monitor resource 140 forwards the current conditions such as indicated by the feedback 172 to control management resource 141 (such as an artificial intelligence engine machine learning engine).

In operation #3, the monitor resource 135 forwards the received conditions to the repository 181 for storage. Via generation of the monitor information 195 (such as including a history corpus), the monitor resource 135 stores a history of the feedback 172 in repository 181.

In operation #4, the control management resource 141 (such as controller) receives the history corpus (such as monitor information 195 including one or more of monitor information 195-1 and monitor information 195-2). In one embodiment, as further discussed herein, the monitor resource 135 or other suitable entity produces ranking information indicating which of the geographical regions is in most need of deployment additional wireless services at different times.

In operation #5, based on the monitor information 195 stored in repository 181, the control management resource 141 produces and outputs control information 145 indicating when, where, and how to deploy the one or more mobile wireless base stations 111, 112, etc.

In operation #6, via the control information 145, the control management resource 141 controls deployment of the respective mobile wireless base station 111 to a target location at a particular time for a time duration. In one embodiment, the control management resource 141 supplies path information in which to travel to a target deployment site. Such deployment may depend on whether conditions. In further example embodiments, the control management resource 141 receives weather information and initiates deployment of the respective mobile wireless base station to avoid inclement weather conditions.

Further in operation #7, during movement of and/or deployment of the respective mobile wireless base station 111 at a target location, the monitor resource 135 continues to receive input information indicating current conditions such as from the wireless base station 111 and/or or other suitable entities in the wireless network environment 100.

The monitor resource 135 can be configured to receive information indicating deployment of the mobile wireless base station and whether the deployment was successful or not in providing appropriate wireless services to mobile communication devices in the target geographical region. For example, in one embodiment, the management resource 140 receives feedback (such as feedback 272 from mobile wireless base station 111 or feedback 172 from one or more entities) indicating a degree of success associated with deployment of the mobile wireless base station 111 to temporarily provide the wireless services in the target geographical region.

In yet further example embodiments, based on feedback from the mobile wireless base station 111 or other suitable entities, the monitor resource 135 (management resource 140) produces and stores historical information such as success/failure associated with given deployment in the repository 181. Such information (success or failure) is used at least partially as a basis in which to determine whether to subsequently deploy the mobile wireless base station in a similar manner in the future.

In an example embodiment, assume that the management resource 140 anticipates occurrence of a subsequent congestion condition in the geographical region R3 based on the stored history of wireless access information 195 in repository 181. For example, in a manner as previously discussed, assume that prior to the deployment of the mobile wireless base station 111, the monitor resource 135 associated with management resource 140 monitors delivery of content in the different geographical regions (such as geographical region R1 serviced by wireless base station 121 at location L21, geographical region R2 serviced by wireless base station 122 at location L22, geographical region R3 serviced by wireless base station 123 at location L23, etc.). Via feedback (172, 272, etc.) from one or more wireless base stations or other suitable entities, the monitor resource 135 receives performance metrics indicating whether the corresponding geographical region needs deployment of additional wireless network access services.

In one embodiment, the feedback 172 of monitoring the wireless network environment 100 indicates conditions such as the inability of the wireless base station 123 and wireless base station 121 to provide adequate wireless network access services in respective geographical regions R1, R3, etc.

As further shown, the monitor information 195 can including ranking information indicating a priority (such as priority ranking level PR1 such as a highest ranking, priority ranking level PR2 such as a second highest ranking, . . . , priority ranking level PR6 such as a sixth highest ranking, etc.) of deploying the available mobile wireless base stations.

In this example embodiment, based on received feedback and monitoring: i) the monitor information 195-1 indicates the wireless base station 121 supports 295 mobile communication devices in geographical region R1; ii) the monitor information 195-1 indicates the wireless base station 122 supports 195 mobile communication devices in geographical region R2; i) the monitor information 195-1 indicates the wireless base station 123 supports 567 mobile communication devices in geographical region R3; and so on. The geographical region most in need of extra wireless network access services is geographical region R3.

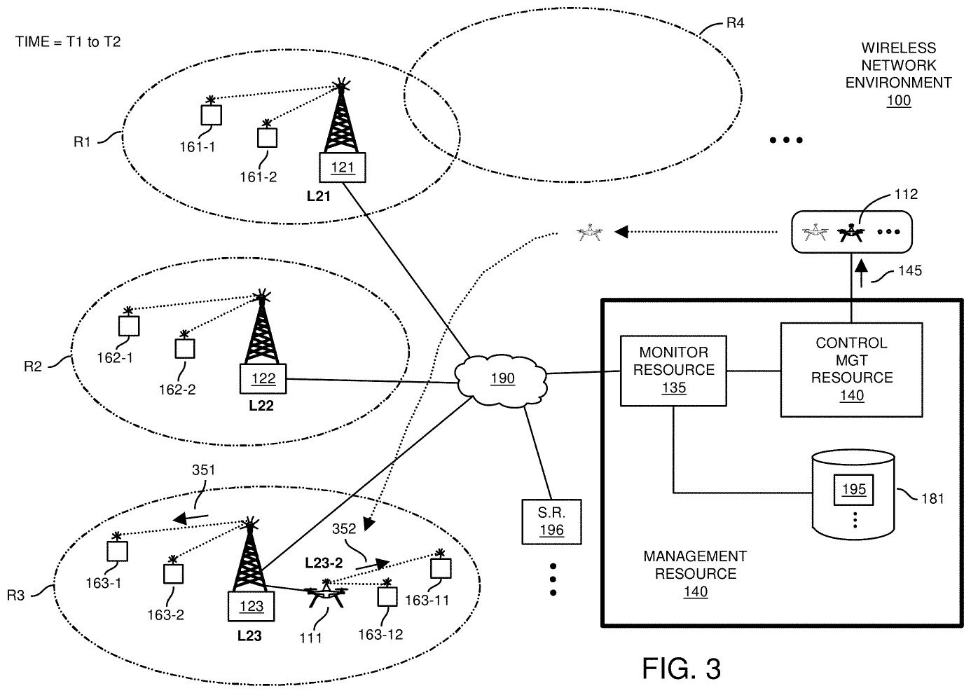

Assume in this example embodiment that in addition to detecting a first condition indicating the temporary need for additional wireless services in geographical region R1, the monitor resource 135 detects a second condition indicating a temporary need for additional wireless services in geographical region R3 at or around the same time. In one embodiment, availability of wireless resources such as multiple mobile wireless base station 111, 112, etc., are limited. In such an instance, the control management resource 141 may not be able to deploy a respective mobile wireless base station to each geographical region (such as zone) requiring wireless network access services. To provide fair deployment of the mobile wireless base stations, the management resource 140 produces ranking information ranking the need to provide additional wireless services in the different geographical regions. For example, the management resource 140 assigns priority ranking value PR6 to the geographical region R1; the management resource 140 assigns priority ranking value PR1 to the geographical region R3; and so on. In such an instance, if only one mobile wireless base station 111 is available for deployment during detected need for additional wireless resources, then the communication management resource 140 deploys the available mobile wireless base station 111 to the geographical region ranked highest in the ranking information. In this case, the management resource 140 deploys the mobile wireless base station 111 to the geographical region R3 as further shown in FIG. 3 because the geographical region R3 is ranked highest as needing extra wireless network access services.

Based on received input, the monitor resource 135 produces monitor information 195-2 to indicate the need for wireless network access services in the geographical region R4 at time T4-T5 (such as March 26, between 1:00 pm and 4 pm).

FIG. 3 is an example diagram illustrating implementation of a mobile wireless base station in response to detected congestion in a wireless network environment according to embodiments herein.

In accordance with the monitor information 195-1, and corresponding ranking information, the control management resource 141 deploys the available mobile wireless base station 111 to the geographical region R3 in response to detecting current wireless network conditions (such as congestion) or determining from past history that the geographical region R3 experiences a need for additional wireless network access services at a particular time of day, day of week, etc.

In this example embodiment, between time T1 and time T2, both the mobile wireless base station 111 and the wireless base station 123 provide wireless network access services to communication devices in the geographical region R3. For example, the wireless base station 123 at location L23 provides wireless connectivity to the mobile communication devices 163-1, 163-2, etc., so that such communication devices can access the remote network 190 and corresponding server resources 196. The mobile wireless base station 111 deployed at location L23-2 provides wireless connectivity to the mobile communication devices 163-11, 163-12, etc., so that such communication devices can access the remote network 190 and corresponding server resources 196.

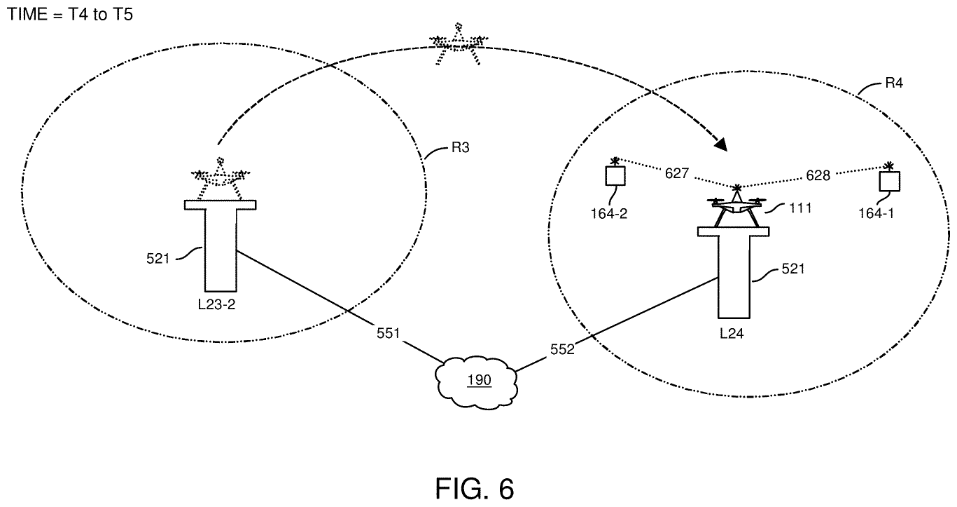

The mobile wireless base station 111 is in communication with the network 190 in any number of ways. In one embodiment, the mobile wireless base station 111 is in wireless communication with the wireless base station 123. In such an instance, the wireless base station 123 provides the mobile wireless base station 111 and corresponding communication devices 163-11, 163-12, etc., access to the network 190. Additionally, or alternatively, as in FIG. 6, the mobile wireless base station 111 can be configured to dock at a respective docking station that is connected to a physical communication link supporting connectivity of the mobile wireless base station 111 to the remote network 190.

Referring again to FIG. 3, in still further example embodiments, the mobile wireless base station 111 receives handoff of wireless communication devices (such as 163-11, 163-12, etc.) from the wireless base station 123. Further embodiments herein include implementing load balancing so that each of the wireless base station 123 and the mobile wireless base station 111 share a respective load of supporting communication devices connectivity to the remote network 190.

In still further example embodiments, the control management resource 141 controls the mobile wireless base station 111 to transmit a wireless discovery signal 352 (such as a wireless beacon) in the geographical region R3. The wireless signal 352 indicates availability of the additional wireless services in the geographical region R3. In one embodiment, the wireless signal 352 includes information (data) indicating an identity of a wireless network service provider XYZ (such as associated with Company XYZ) providing the additional wireless services from the mobile wireless base station 111. In one embodiment, wireless network service provider XYZ also provides wireless network access services from wireless base station 123.

In accordance with further example embodiments, the wireless base station 123 broadcasts wireless signal 351 in the geographical region R3. In one embodiment, the wireless signal 351 indicates availability of the standard wireless services available in the geographical region R3 from wireless network service provider XYZ. In an example embodiment, the wireless signal 352 transmitted from the wireless base station 123 indicates an identity of wireless network service provider XYZ providing the base wireless services from the wireless base station 123.

Note that inclusion of the unique identifier value XYZ or other suitable value in each communications 351 and 352 enables the respective communication devices to detect that both the wireless base station 123 and the temporarily deployed mobile wireless base station 111 are part of the same wireless network to which the users of the communication devices 163 subscribe.

In this example embodiment, the mobile wireless base station 111 is deployed between time T1 and time T2 to provide the temporary needed wireless services. At time T2, the control management resource 141 can be configured to deploy the wireless base station 111 to another location in the wireless network environment 100.

In further example embodiments, based on attributes of the detected condition and types of content retrieved by the users and corresponding communication devices in the geographical region R3, the monitor resource 135 identifies a first type of data expected or actually retrieved by communication devices in the geographical region R3. In one embodiment, to provide better services, the mobile wireless base station 111 (such as an edge device) stores the first type of data for subsequent retrieval by the one or more communication devices 163. Based on respective requests for the first type of data from the respective communication devices, the mobile wireless base station 111 distributes the first type of data from the mobile wireless base station 111 to the one or more requesting communication devices 163. Storing desired data at the mobile wireless base station (such as edge device) in a wireless network environment 100 provides more efficient distribution of content in the wireless network environment 100.

Thus, in accordance with further example embodiments, the extra capacity (such as storage, cache, etc.) provided by the mobile wireless base stations (such as edge devices) stores content that is retrieved by more than one consumer (such as users operating respective mobile communication devices). In one embodiment, the content is retrieved prior to receiving one or more requests from the communication devices. Additionally, or alternatively, the mobile wireless base stations monitor the different content being retrieved by users. For a title of specific content frequently retrieved by multiple users, the respective mobile wireless base station stores that content in its cache so that it does not need to repeatedly retrieve the content from network 190.

As previously discussed, in one embodiment, each of the mobile wireless base stations 111, 112, etc., is a so-called edge device that provides an entry point into enterprise or service provider core networks. The mobile wireless base stations implement functionality associated with network devices such as routers, routing switches, integrated access devices (IADs), multiplexers, and a variety of metropolitan area network (MAN) and wide area network (WAN) access devices.

Deployment of the mobile wireless base stations and corresponding extra storage capacity (caching) as discussed herein reduces stress on the wireless network. For example, by deploying the mobile wireless base stations 111, 112, etc., in appropriate locations of need, the corresponding communication devices that are consuming the same content are enabled to utilize the edge storage (such as cache capacity) associated with the mobile wireless base stations, which minimizes redundant traffic. In other words, in response to receiving requests for the same content, the mobile wireless base stations retrieve the requested content from their own storage (cache) and distribute the requested content to the requesting communication devices instead of having to retrieve the requested content from server resources 196 to distribute the content to requesting communication devices.

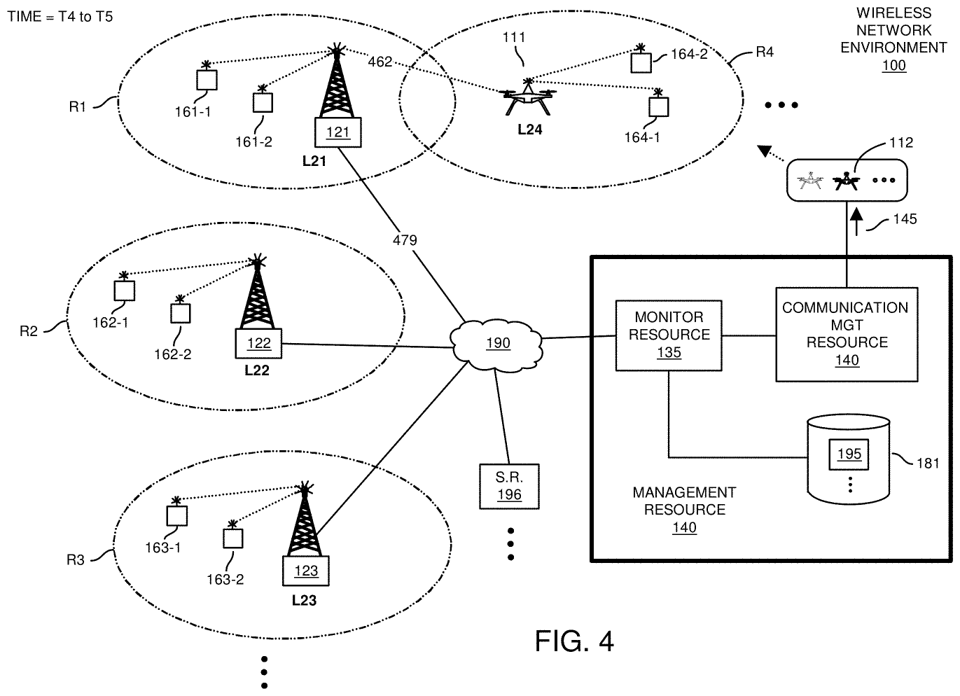

FIG. 4 is an example diagram illustrating implementation of a mobile wireless base station at an event such as a private or public gathering of people according to embodiments herein.

As previously discussed, the monitor resource 135 detects a condition in which there is a scheduled gathering of people in the geographical region R4 at or around time T4 to T5.

In such an instance, in accordance with the monitor information 195-2 (FIG. 2), and via the control management resource 141, the management resource 140 deploys the mobile wireless base station 111 to operate in a vicinity of the geographical region R4 at the time (T4 to T5) of the scheduled gathering to support the temporary need for additional wireless services during the event. Referring again to FIG. 4, between time T4 and T5, the mobile wireless base station 111 deployed to the geographical region R4 provides communication devices 164-1, 164-2, etc., wireless connectivity to the remote network 190 and corresponding server resources 196. In one embodiment, the mobile wireless base station 111 provides the wireless connectivity via wireless backhaul link 462; communication link 479 further conveys the communications between network 190 and the remote network 190.

In a similar manner as previously discussed, based on attributes of the scheduled event at geographical region R4 and types of content expected or actually retrieved by the users and corresponding communication devices 164 in the geographical region R4, the monitor resource 135 identifies a type of data expected or actually retrieved by communication devices in the geographical region R4. In one embodiment, to provide better services, the mobile wireless base station 111 (such as an edge device) stores the detected type of data for subsequent retrieval by the one or more communication devices 164. Based on respective requests for the second type of data from the respective communication devices between time T4 and T5, the mobile wireless base station 111 distributes the type of data such as associated with the scheduled event from the mobile wireless base station 111 to the one or more requesting communication devices 164.

In one embodiment, the control information 145 notifies the mobile wireless base station 111 which data is to be retrieved and cached for the respective deployment in the geographical region R4.

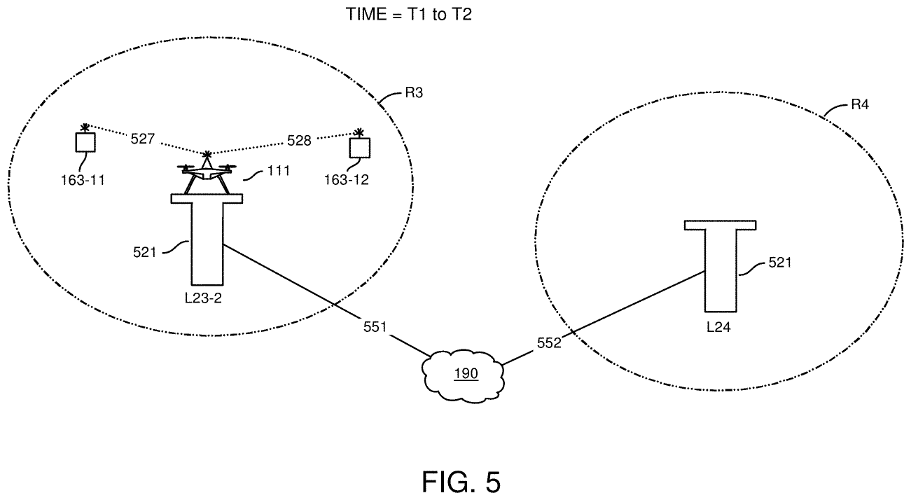

FIG. 5 is an example diagram illustrating implementation of one or more docking stations to accommodate mobile wireless base stations according to embodiments herein.

As previously discussed in FIG. 2, the monitor resource 135 receives feedback indicating that both the geographical region R1 and geographical region R3 need additional wireless services.

Referring again to FIG. 5, based on an amount of congestion or other performance metric as each of the geographical regions, the monitor resource 135 or other suitable entity assigns the priority level PR1 (Priority Ranking #1) to the geographical region R3; the monitor resource 135 or other suitable entity assigns the priority level PR6 (Priority Ranking #6) to the geographical region R1. Assume that the ranking PR1 is higher priority than PR6, and that only mobile wireless base station 111 is available for dispatch to provide additional wireless network services, the management resource 140 selects geographical region R3 in which to dispatch the mobile wireless base station 111 between time T1 and T2.

In this example embodiment, each of the geographical regions R3 and R4 include a docking station. For example, geographical region R3 includes docking station 521 disposed at location L23-2. Geographical region R4 includes docking station 522 disposed location L24. To provide additional wireless network services to the geographical region R3, the control management resource 141 produces control information 145 that dispatches the mobile wireless base station 111 to the docking station 521 at location L23-2. In this example embodiment, between time T1 and time T2, in accordance with the control information 145, the mobile wireless base station 111 (affixed to docking station 521) provides additional wireless services to the communication devices 163-11 and communication device 163-12 while wireless base station 123 continues to provide wireless services to communication devices 163-1 and 163-2 in a manner as previously discussed.

In one embodiment, when the mobile wireless base station 111 lands on respective docking station 521, the docking station 521 provides power to the mobile wireless base station 111 to recharge its batteries and to power the corresponding wireless base station affixed to it.

In further example embodiments, the docking station 521 includes a physical communication link 551 providing a connection from the docked mobile wireless base station 111 to the network 190. Alternatively, in a manner as previously discussed, the mobile wireless base station 111 can be configured to wirelessly communicate with network 190 of corresponding wireless base station.

As further discussed below, when the additional wireless services are no longer needed by the communication devices in the geographical region R3, the control management resource 141 generates additional control information 145 and communicates it to the mobile wireless base station 111. The updated control information 145 from the control management resource 141 causes, at the appropriate time, the mobile wireless base station 111 to disembark from the docking station 521 to the docking station 522. In a similar manner as previously discussed, the control information 145 can include flight information indicating a specific flight path (such as altitude, speed, location, etc.) in which to travel from the docking station 521 to the docking station 522.

FIG. 6 is an example diagram illustrating movement of a mobile wireless base station from one docking station to another docking station to provide users in different geographical regions wireless network access according to embodiments herein.

As previously discussed, assume that the monitor resource 135 receives input indicating the need for wireless services in the geographical region R4 at or around time T4 to time T5 to provide wireless services to respective user's attending the event occurring in geographical region R4 at that time. In such an instance, the communication management resource 140 produces the control information 145 and communicates it to the mobile wireless base station 111.

The updated control information 145 received from the control management resource 141 causes, at the appropriate time, the mobile wireless base station 111 to disembark from the docking station 521 to the docking station 522. In one embodiment, the control information 145 includes flight information indicating a specific flight path (such as altitude, speed, location, etc.) in which to travel from the docking station 521 to the docking station 522.

When the mobile wireless base station 111 lands on respective docking station 522, the docking station 522 provides power to the mobile wireless base station 111 to recharge its batteries and to power the corresponding wireless base station affixed to it.

In further example embodiments, the docking station 522 includes a physical communication link 552 providing a connection from the docked mobile wireless base station 111 to the network 190. Alternatively, in a manner as previously discussed, the mobile wireless base station 111 can be configured to wirelessly communicate with network 190 of corresponding wireless base station.

While at the docking station 522 between time T4 and T5, the mobile wireless base station 111 provides the additional wireless network services to the communication devices present in the geographical region R4.

More specifically, via a respective wireless communication link 627, the communication device 164-2 transmits data to network 190 via a combination path including wireless communication link 627 and communication link 552; the communication device 164-2 receives data from network 190 via a combination path including communication link 552 and wireless communication link 627. Via a respective wireless communication link 628, the communication device 164-1 transmits data to network 190 via wireless communication link 628 and communication link 552; the communication device 164-1 receives data from network 190 via communication link 552 and wireless communication link 628.

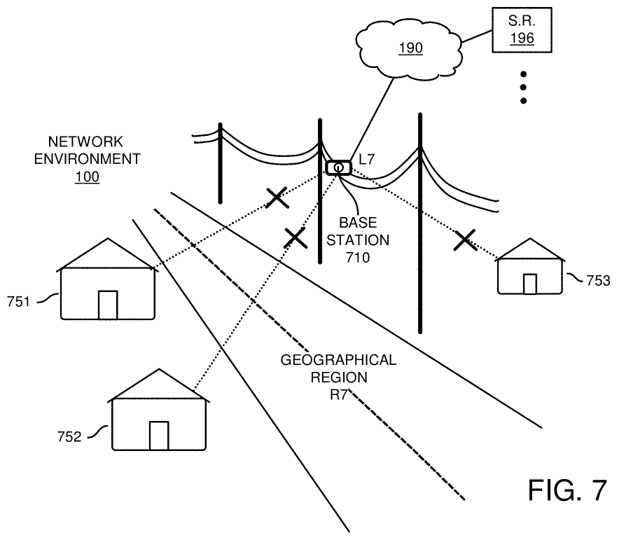

FIG. 7 is an example diagram illustrating an outage of a wireless base station according to embodiments herein.

In this example embodiment, assume that the wireless network environment 100 includes geographical region R7 including multiple subscriber domains 751, 752, 753, etc., that rely on a wireless base station 710 at location R7 to receive wireless access to network 190 such as the Internet.

Assume that the wireless base station 710 disposed in an aerial location L7 experiences a failure and is unable to provide wireless access to the subscriber domains 751, 752, 753, etc.

In such an instance, the management resource 140 receives feedback indicating the wireless network service outage. To accommodate and correct the wireless network service outage, the management resource 140 initiates a so-called truck roll in which a respective technician is dispatched to fix the problem wireless base station 710. In one embodiment, as further discussed below, the dispatch includes implementation of a mobile wireless base station to provide at least temporary wireless access services to the subscriber domains 751, 752, 753, etc., while the wireless base station 710 is being fixed.

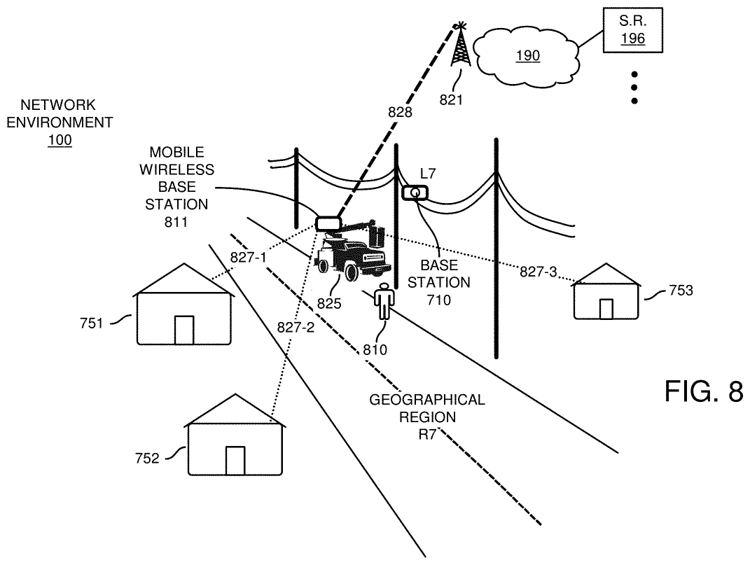

FIG. 8 is an example diagram illustrating implementation of a mobile wireless base station affixed to a service truck to provide wireless services during a wireless base station outage according to embodiments herein.

For example, in this example embodiment, the management resource 140 dispatches the utility truck 825 and corresponding technician 810. While the wireless base station 710 is being fixed, the mobile wireless base station 811 is mounted on the truck 825 to provide temporary wireless services to the subscriber domain 751, 752, 753, etc.

More specifically, via wireless communication link 827-1, the subscriber domain 751 and corresponding communication devices are provided wireless connectivity to the mobile wireless base station 811; via wireless communication link 827-2, the subscriber domain 752 and corresponding communication devices are provided wireless connectivity to the mobile wireless base station 811; via wireless communication link 827-3, the subscriber domain 753 and corresponding communication devices are provided wireless connectivity to the mobile wireless base station 811; and so on.

As further shown, the mobile wireless base station 811 is in wireless communication with the wireless base station 821 (or other suitable entity). Via communications over a combination of the wireless communication links 827-1 and wireless communication link 828, the respective communication devices associated with subscriber domain 751, 752, 753, etc., are provided wireless access to the network 190.

In one embodiment, both the wireless base station 710 and mobile wireless base station 811 are configured with identity information facilitating substitution. For example, the wireless base station 810 is configured to broadcast beacon information indicating its presence (when working properly) and an identity of the wireless network service provider (wireless network service provider #1) enabling the communication devices associated with the subscriber domains to connect to it. The mobile wireless base station 811 is also configured to broadcast beacon information indicating its presence and an identity of the wireless network service provider (wireless network service provider #1) enabling the communication devices associated with the subscriber domains to connect to it.

Subsequent to repair or replacement of the wireless base station 710, the subscriber domains and corresponding communication devices then wirelessly connect to the wireless base station 710 to access the remote network 190. In one embodiment, the temporary mobile wireless base station 811 or other suitable entity initiates a wireless handoff of each of the communication devices associated with subscriber domains 751, 752, 753, etc., from the mobile wireless base station 811 to the wireless base station 710 such that the communication devices do not experiences an outage again during handoffs.

As previously discussed, the one or more mobile wireless base stations as discussed herein can be deployed in any suitable manner. For example, in one embodiment, the communication management resource 140 deploys the mobile wireless base station 811 on a ground-based vehicle (such as a truck 825, automobile, etc.) steered to the desired location L7 where the temporary wireless services wireless services are needed. In accordance with another example embodiment, as previously discussed above, the communication management resource 140 deploys the mobile wireless base stations in respective an air-based vehicles (such as a drones, balloons, etc.) steered to the desired location where wireless services are needed.

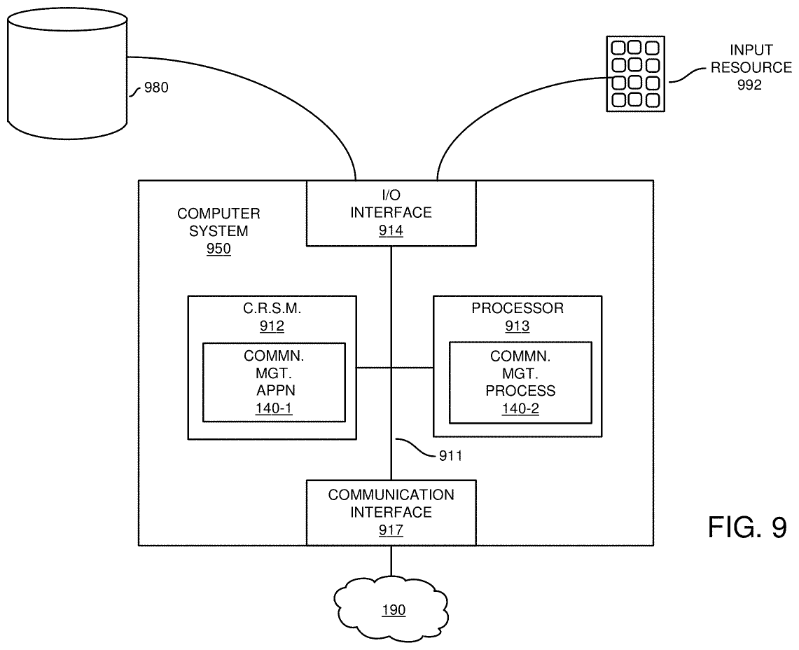

FIG. 9 is an example block diagram of a computer system for implementing any of the operations as previously discussed according to embodiments herein.

Any of the resources (such as control management resource 140, control management resource 141, management resource 135, mobile wireless base station, etc.) as discussed herein can be configured to include computer processor hardware and/or corresponding executable instructions (such as management application 140-1) to carry out the different operations as discussed herein.

As shown, computer system 950 of the present example includes an interconnect 911 that coupling computer readable storage media 912 such as a non-transitory type of media (which can be any suitable type of hardware storage medium in which digital information can be stored and retrieved), a processor 913 (computer processor hardware), I/O interface 914, and a communications interface 917.

I/O interface(s) 914 supports connectivity to repository 980 and input resource 992.

Computer readable storage medium 912 can be any hardware storage device such as memory, optical storage, hard drive, floppy disk, etc. In one embodiment, the computer readable storage medium 912 stores instructions and/or data.

As shown, computer readable storage media 912 can be encoded with management application 140-1 (e.g., including instructions) to carry out any of the operations as discussed herein.

During operation of one embodiment, processor 913 accesses computer readable storage media 912 via the use of interconnect 911 in order to launch, run, execute, interpret or otherwise perform the instructions in management application 140-1 stored on computer readable storage medium 912. Execution of the management application 140-1 produces management process 140-2 to carry out any of the operations and/or processes as discussed herein.

Those skilled in the art will understand that the computer system 950 can include other processes and/or software and hardware components, such as an operating system that controls allocation and use of hardware resources to execute management application 140-1.

In accordance with different embodiments, note that computer system may reside in any of various types of devices, including, but not limited to, a mobile computer, a personal computer system, wireless station, connection management resource, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 950 may reside at any location or can be included in any suitable resource in any network environment to implement functionality as discussed herein.

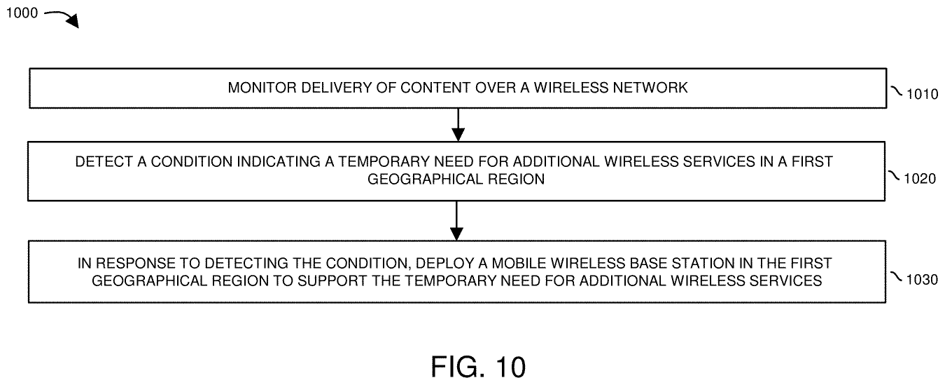

Functionality supported by the different resources will now be discussed via flowcharts in FIG. 10. Note that the steps in the flowcharts below can be executed in any suitable order.

FIG. 10 is a flowchart 1000 illustrating an example method according to embodiments. Note that there will be some overlap with respect to concepts as discussed above.

In processing operation 1010, the management resource 140 monitors delivery of content over a wireless network 100.

In processing operation 1020, the management resource 140 detects a condition indicating a temporary need for (primary or additional) wireless services in a geographical region (such as region R3 or R4).

In processing operation 1030, in response to detecting the condition, the management resource 140 deploys a mobile wireless base station 111 in the geographical region (such as R3 or R4) to support the temporary need for primary or additional wireless services.

### Further Embodiments

Embodiments herein include:
Capturing and tracking historical usage patterns and capacity in one or more geographical regions
Capturing, from sensors, environmental conditions (e.g., event, scheduled time, weather conditions, etc.)
Analyzing data patterns to identify high level usage locations and source of content (e.g., content transmitting from a school)
Building a corpus (history) of conditions that contains historical usage, bandwidth usage capacity, environmental conditions, and data sources for future capacity (mobile wireless base station) relocation
Capturing current conditions (e.g., including predicted such as school is in session Mon till 3 PM)
Determining if capacity shortfalls exist and/or network throughput in a particular geographical region and wireless base station can be improved by relocating mobile wireless base stations to such locations
Ranking improvements (e.g. most consumers see improved network availability even those not using the mobile capacity) to determine relocating capacity recommendations and deployment of respective mobile wireless base stations at different times
Deploying wireless base station vehicles to locations that will allow deployment of appropriate wireless network access services (such as where capacity is allowed to be deployed) and storing identified/predicted common data to be distributed from the one or more deployed mobile wireless base stations

### Building of a Corpus (Monitor Information) Including Historical Information

Embodiments herein include capturing data from multiple feeds to build a corpus of information (such as monitor information 195) which will be used for predicting future capacity. This includes operations such as:
Capturing usage and capacity from network devices (communication devices, wireless base stations, etc.).
Logging the usage and capacity to the system
Logging environmental conditions at a given time
Capturing special events from public web services that may change patterns (bi-directional).
Building a corpus by matching the above information by date/time/events/capacity
Training the system to eliminate or include events that are most relevant (e.g. super bowl is, high school football probably not)

### Method to Capture Current and Predicted Conditions

Embodiments herein include capturing data from multiple feeds to build a set of information that will be analyzed against the corpus in a future step. For example, embodiments herein include:
Capturing current usage and capacity of wireless network access services by network devices.
Capturing current conditions
Capturing special events from public web services that may change patterns (bi-directional).

### Method to Build Corpus Containing Historical Information

Embodiments herein include capturing data from multiple feeds to build a corpus of information which will be used for predicting future capacity. For example, embodiments herein include:
Capturing historical usage and capacity from network devices.
Logging the usage and capacity to the system
Logging environmental conditions at a given time
Capturing special events from public web services that may change patterns (bi-directional).
Building a corpus by matching the above information by date/time/events/capacity
Training the system to eliminate or include events that are material (e.g. super bowl is, high school football probably not)

### Method to Identify Possible Capacity Relocation

Embodiments herein include use of current and predicted conditions and usage of wireless network resources to determine movement of mobile wireless base station capacity. For example, embodiments herein include:
Identifying any short capacity locations
Identifying any remote capacity that is enabling network improvement (e.g usage of mobile network)
Comparing current/predicted needs with corpus to identify capacity short falls or overage
Based on ranked list, determining if there is a location that mobile capacity can be moved to (areas will need to be pre-configured)
Determining if any capacity needs to have mobile capacity (e.g., drone) recharged). If yes, do not deploy the move
Ranking future location improvements
Use ranking to determine optimal placement by looking at all combinations of movement
Determining if capacity shortfalls exist and/or network throughput can be improved by relocating capacity
Ranking improvements (e.g. most consumers see improved network availability even those not using the mobile capacity) to determine relocating capacity recommendations
Moving wireless base station vehicles to locations that will allow deployment of capacity (and where capacity is allowed)

Note again that techniques herein are well suited to facilitate wireless connectivity to communication devices operated in a network environment. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

I claim:

1. A method comprising:
monitoring a wireless network;
detecting a condition indicating a temporary need for wireless services in a first geographical region; and
in response to detecting the condition, deploying a mobile wireless base station in the first geographical region to support the temporary need for wireless services.

2. The method as in claim 1, wherein the condition is a scheduled gathering of people in the first geographical region.

3. The method as in claim 2 further comprising:
deploying the mobile wireless base station in a vicinity of the first geographical region at a time of the scheduled gathering to support the temporary need for additional wireless services.

4. The method as in claim 1, wherein the condition indicates an inability of fixed wireless base station resources in the first geographical region to provide sufficient network access to mobile communication devices in the first geographical region.

5. The method as in claim 1, wherein monitoring the delivery of content includes storing a history of wireless network access by users in the first geographical region over time; and
wherein detecting the condition includes: anticipating occurrence of the condition in the first geographical region based on the stored history of wireless access.

6. The method as in claim 1 further comprising:
based on attributes of the detected condition, identifying a first type of data expected to be retrieved by communication devices in the first geographical region;
caching the first type of data expected to be retrieved by the communication devices from the wireless mobile base station; and
distributing the first type of data from the mobile wireless base station to the communication devices.

7. The method as in claim 1 further comprising:
deploying the mobile wireless base station on a ground-based vehicle.

8. The method as in claim 1 further comprising:
deploying the mobile wireless base station in an air-based vehicle.

9. The method as in claim 1 further comprising:
receiving feedback indicating a degree of success associated with deployment of the mobile wireless base station to temporarily provide the additional wireless services in the first geographical region.

10. The method as in claim 9 further comprising:
receiving the feedback from the mobile wireless base station.

11. The method as in claim 1, wherein monitoring delivery of content over a wireless network includes:
monitoring delivery of content in the first geographical region in which the wireless network resides; and
monitoring delivery of content in a second geographical region in which the wireless network resides.

12. The method as in claim 1, wherein the condition is a first condition, the method further comprising:
detecting a second condition indicating a temporary need for additional wireless services in the second geographical region; and
producing ranking information ranking the temporary need to provide additional wireless services in the first geographical versus the temporary need to provide additional wireless services in the second geographical region.

13. The method as in claim 1 further comprising:
controlling the mobile wireless base station to transmit a wireless signal in the first geographical region, the wireless signal indicating availability of the additional wireless services.

14. The method as in claim 13 further comprising:
controlling the mobile wireless base station to transmit a wireless signal in the first geographical region, the wireless signal indicating an identity of a wireless network service provider providing the additional wireless services from the mobile wireless base station.

15. A system comprising:
communication management hardware operative to:
monitor a wireless network;
detect a condition indicating a temporary need for additional wireless services in a first geographical region; and
in response to detecting the condition, deploy a mobile wireless base station in the first geographical region to support the temporary need for additional wireless services.

16. The system as in claim 15, wherein the condition is a scheduled gathering of people in the first geographical region.

17. The system as in claim 16, wherein the communication management hardware is further operative to:
deploy the mobile wireless base station in a vicinity of the first geographical region at a time of the scheduled gathering to support the temporary need for additional wireless services.

18. The system as in claim 15, wherein the condition indicates an inability of fixed wireless base station resources in the first geographical region to provide sufficient network access to mobile communication devices in the first geographical region.

19. The system as in claim 15, wherein the communication management hardware is further operative to:
store a history of wireless network access by users in the first geographical region over time; and
anticipate occurrence of the condition in the first geographical region based on the stored history of wireless access.

20. The system as in claim 15, wherein the communication management hardware is further operative to:
based on attributes of the detected condition, identify a first type of data expected to be retrieved by communication devices in the first geographical region;
store the first type of data expected to be retrieved by the communication devices from the wireless mobile base station; and
distribute the first type of data from the mobile wireless base station to the communication devices.

21. The system as in claim 15, wherein the communication management hardware is further operative to:
deploy the mobile wireless base station on a ground-based vehicle.

22. The system as in claim 15, wherein the communication management hardware is further operative to:
deploy the mobile wireless base station in an air-based vehicle.

23. The system as in claim 15, wherein the communication management hardware is further operative to:
receive feedback indicating a degree of success associated with deployment of the mobile wireless base station to temporarily provide the additional wireless services in the first geographical region.

24. The system as in claim 23, wherein the communication management hardware is further operative to:
receive the feedback from the mobile wireless base station.

25. The system as in claim 15, wherein the communication management hardware is further operative to:
monitor delivery of content in the first geographical region in which the wireless network resides; and
monitor delivery of content in a second geographical region in which the wireless network resides.

26. The system as in claim 15, wherein the condition is a first condition, the communication management hardware further operative to:
detect a second condition indicating a temporary need for additional wireless services in the second geographical region; and
produce ranking information ranking the temporary need to provide additional wireless services in the first geographical versus the temporary need to provide additional wireless services in the second geographical region.

27. The system as in claim 15, wherein the communication management hardware is further operative to:
control the mobile wireless base station to transmit a wireless signal in the first geographical region, the wireless signal indicating availability of the additional wireless services.

28. The system as in claim 15, wherein the communication management hardware is further operative to:
control the mobile wireless base station to transmit a wireless signal in the first geographical region, the wireless signal indicating an identity of a wireless network service provider providing the additional wireless services from the mobile wireless base station.

29. Computer-readable storage hardware having instructions stored thereon, the instructions, when carried out by computer processor hardware, cause the computer processor hardware to:
monitor a wireless network;
detect a condition indicating a temporary need for additional wireless services in a first geographical region; and
in response to detecting the condition, deploy a mobile wireless base station in the first geographical region to support the temporary need for additional wireless services.
